(19) United States
(12) Patent Application Publication
(10) Pub. No.: US 2004/0185896 A1
(43) Pub. Date: Sep. 23, 2004

(54) Controlled processing of audio and command data in a digital cordless telephone

(76) Inventors: Wilhelm Ernst Riedl, Indianapolis, IN (US); Hung Chi Lai, Indianapolis, IN (US); David Lee Kechkaylo, Indianapolis, IN (US)

Correspondence Address: THOMSON MULTIMEDIA LICENSING INC, JOSEPH S TRIPOLI, PO BOX 5312, 2 INDEPENDENCE WAY, PRINCETON, NJ, 08543-5312, US

(21) Appl. No.: 10/394,669

(22) Filed: Mar. 21, 2003

(51) Int. Cl. H04B 1/38

(52) U.S. Cl. 455/550.1; 455/73

(57) ABSTRACT

A circuit for controlling processing of audio data and command data in a digital cordless telephone receiver includes a digital audio data path for processing digital audio information received; and a command data path for controlling the digital audio data path responsive to receiving command data.

### BACKGROUND

1. Technical Field

This disclosure relates to telephones and, more particularly to a receiver feature for processing audio data and command data in a digital cordless telephone.

2. Description of the Related Art

In digital cordless phone systems digital audio information received is processed to facilitate a conversation. During the conversation, pressing out a keyed sequence to send command data would be heard by the listener as the keyed sequence would be processed along with the digital audio information. Various techniques have been employed to send command data and digital audio information in such a way that the command data is processed separate from the digital audio information.

Digital cordless systems based on the digital enhanced cordless telecommunications standard (DECT) protocol as well as those using direct sequence spread spectrum technologies imbed the command data into the same data stream as the digital audio information stream. This requires the standard to have established a specific frame structure that assigns different roles to the digital bits in the frame. Some bits are assigned as overhead bits used for synchronization and others for command data with the remaining bits comprising the digital audio information.

In digital cordless systems that utilize data streaming without requiring that data stream to be framed, command data is interleaved with the audio information. A mechanism is needed at the receiving end to determine whether a specific command data sequence was received by constantly comparing the content of the received data stream to determine if a command data match was received. Upon this determination a pattern is generated that emulates a string of “silent audio” data that is exchanged with the command data stream in order to prevent the listener on the receiving end to be disturbed by the decoded noise-like interpretation of the command data.

Accordingly, there is a need for a simple apparatus and method for digital cordless telephones for holding audio data processing in standby while processing command data.

### SUMMARY OF THE INVENTION

A circuit for controlling the processing of audio data and command data in a digital cordless telephone receiver includes a digital audio data path for processing digital audio information received and a command data path for controlling the digital audio data path responsive to receiving command data. Preferably, the command data path includes a filter for passing the command data and blocking the digital audio information, a converter for converting the command data from the filter to a digital command data stream, and a processor for muting the digital audio information in response to the digital command data stream.

A method for controlling the processing of digital audio information and command data in a digital cordless telephone includes the steps of separating command data from digital audio data in a digital data stream, processing the command data in a separate step, and muting of the digital audio data in the digital data stream responsive to the processing of the command data. In an exemplary embodiment, the step of separating includes filtering the command data from the digital audio stream and the processing includes converting the command data from the filtered digital command data stream into command data bits.

A computer readable medium containing software instructions that, when executed by a processor in a cordless telephone, performs the steps of processing command data separated from a digital data stream containing the command data and digital audio data, and muting of the digital audio data in response to the processing of the command data.

These and other objects, features, and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of the preferred embodiment with reference to the following figure:

FIG. 1 is a block diagram of an exemplary circuit for a digital cordless telephone receiver in accordance with the present invention; and

FIG. 2 is a block diagram of basic components of a cordless telephone.

### DETAILED DESCRIPTION OF PREFERRED EMBODIMENTS

The present invention provides digital cordless telephone equipment with a low cost adoption of existing analog muting methods during command data transmission of the audio digital data stream.

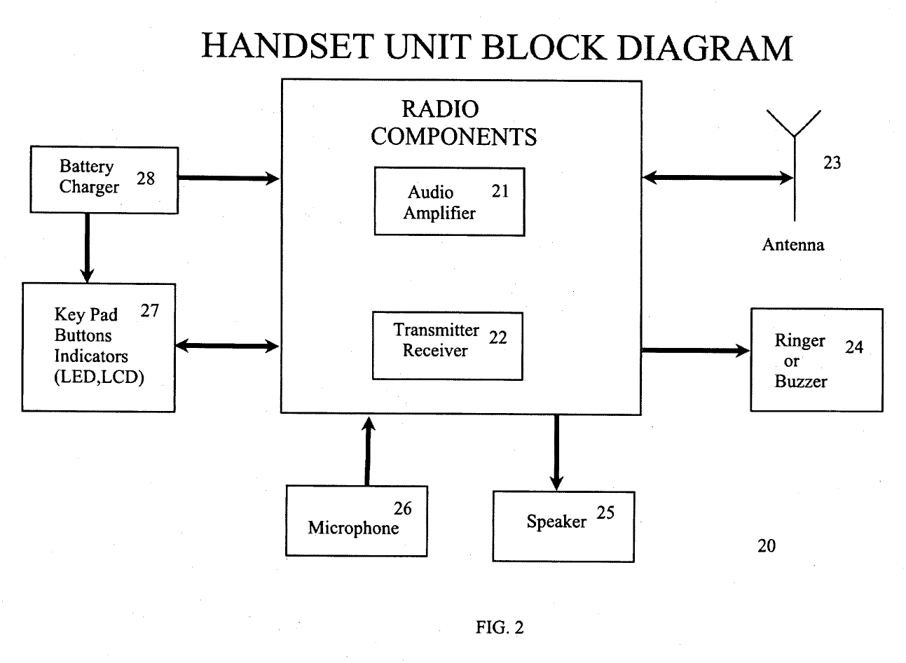

Referring to the block diagram 20 of FIG. 2, the basic components of a cordless telephone handset include radio components such as an audio amplifier 21 and transmitter/receiver 22, an antenna 23, ringer or buzzer 24, speaker 25, microphone 26, key pad buttons and LED or LCD indicators 27, and a battery charger 28. The audio amplifier 21 amplifies electrical signals to and from the microphone and speakers. The transmitter and receiver 22 sends and receives radio frequencies modulated to carry information. Reception of command data in the receiver requires a separate signal processing step to avoid disturbing the user with non-audio data.

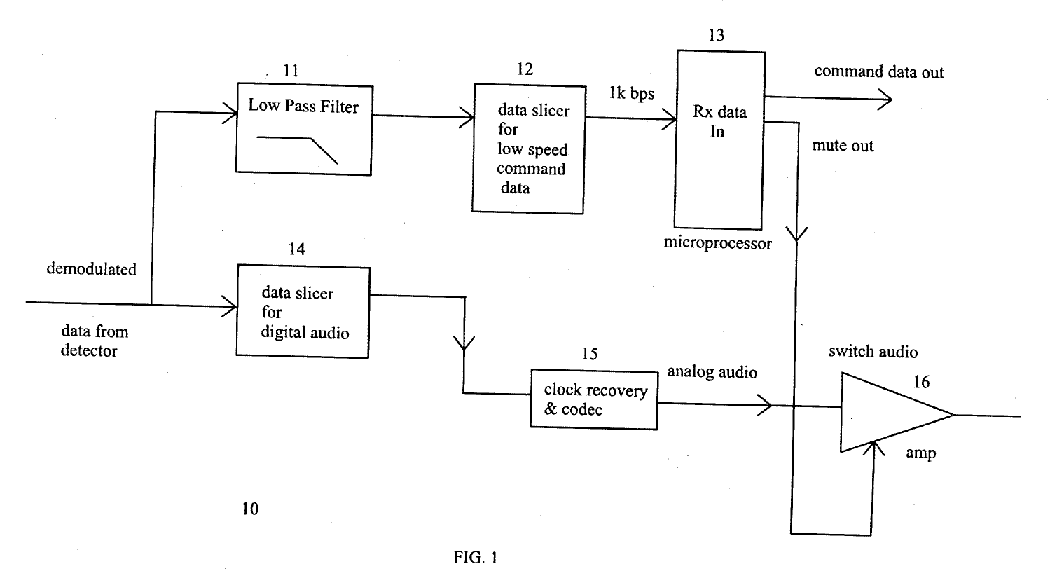

Referring to the block circuit diagram 10 of FIG. 1 there is shown a circuit for muting the recovered digital audio stream during processing of command data. A digital data stream comes to the dual path circuit 10 of FIG. 1 from a detector in the receiver. A command data path includes a low pass filter 11 coupled to a data slicer for low speed command data 12. The data slicer 12 is preferably a 1 bit analog-to-digital (A/D) converter providing a 1 kilobit per second command data stream. The output from the A/D data slicer 12 is tied to a receiver (Rx) data input of a microprocessor 13. The microprocessor 13 controls switching of an amplifier 16 to to mute the decoded digital audio stream received from a detector.

The digital audio path includes a data slicer for digital audio 14. Preferably, the data slicer 14 is a 1 bit analog-to-digital converter providing a 62.5 kilobit digital audio stream. The data slicer 14 output feeds into a clock recovery and coder-decoder (codec) 15 circuit that decodes the continuously variable slope delta modulated (CVSD) digital audio data to analog audio. The coder-decoder (codec) 15 output is coupled to the input of the amplifier 16 that is switched by the mute out from the microprocessor 13 responsive to the command data.

The inventive approach treats the problem of when and how to mute the audio path 16 during the reception of command data. The digital audio is decoded using the continuously variable slope delta modulation (CVSD) decoder 15 that does not require framing and is being continuously fed received data in real time. Command data sent by the transmitter controller is passed through to the command data recovery sequence 11,12,13. The command data rate is a much smaller data rate compared to the audio bit rate. As an example, the digital audio bit rate is equal to 62.5 kb/s and the command data rate is on the order of 1 kb/s. The command data at the lower bit rate is passed through the low pass filter 11, while most of the digital audio energy at the higher bit rate is blocked by the low pass filter 11.

The replacement of command data for the digital audio is accomplished when the continuously variable slope (CVSD) codec 15 is put into a standby state by the microprocessor 13 while simultaneously muting the audio amplifier 16. The mute out signal from the microprocessor disables the digital audio sequence path 14,15 by sending the codec 15 into a standby state. The microprocessor 13 outputs on one of its normally tri-stated outputs the command data for further command processing.

The telephone receiver will have its microprocessor 13 continuously monitor the demodulated incoming data stream from the detector. The telephone receiver will then determine, in exactly the same manner as is being done on analog cordless phone models, whether the data received is valid command data or not and execute its required function. All this is done in such a way that the receiver's microprocessor 13 can determine whether potential command data is expected by sampling the synchronization or preamble part of the command data stream. Once this decision has been made the processor simply mutes or enables the audio receive path 14,15,16 in order for the user not to be annoyed or disturbed by non-audio data.

The inventive circuit for holding audio processing (muting) while processing command data is an advantage over current methods in that its implementation is simple. Digital processing beyond what is already done on the lowest cost analog cordless telephones is not required to implement the inventive circuit. The use of slow speed command data allows for use of inexpensive microprocessors known in analog cordless phone architectures.

Having described a preferred embodiment for holding digital audio data processing (muting) while processing command data (which is intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A circuit for controlling processing of audio data and command data in a digital cordless telephone receiver comprising:
a digital audio data path for processing digital audio information received; and a command data path for controlling said digital audio data path responsive to receiving command data.

2. The circuit in claim 1, wherein said command data path comprises a filter for passing said command data and blocking said digital audio information.

3. The circuit according to claim 1, wherein said digital audio data path comprises an amplifier enabled by said command data path to pass through said digital audio information from said digital audio data path.

4. The circuit according to claim 2, wherein said filter is a low pass filter.

5. The circuit according to claim 2, wherein said command data path comprises a data slicer for said command data coupled from an output of said filter.

6. The circuit according to claim 1, wherein said command data path comprises a processor for controlling pass through of said digital audio information in said digital audio data path.

7. The circuit according to claim 6, wherein said processor is a microprocessor responsive to said command data.

8. The circuit according to claim 1, wherein said command data path comprises a filter for passing said command data and blocking said digital audio information, a converter for converting said command data from said filter to a digital command data stream, and a processor for delaying processing of said digital audio information in response to said digital command data stream.

9. A method for controlling processing of digital audio information and command data in a digital cordless telephone comprising the steps of:
separating command data from digital audio data in a digital data stream;
processing said command data from said separating step; and
delaying processing of said digital audio data in said digital data stream responsive to said processing of said command data.

10. The method according to claim 9, further comprising the step of processing of said digital audio data responsive to a nonexistence of said command data in said digital data stream.

11. The method according to claim 9, wherein said step of separating comprises filtering said command data from said digital audio stream.

12. The method according to claim 11, wherein said step of processing comprises converting said command data from said filtering into a digital command data stream.

13. The method according to claim 12, wherein said delaying comprises disabling passing of said digital audio data through a processing path for said digital audio data.

14. The method according to claim 9, wherein said delaying comprises switching an amplifier in a processing path for said digital audio data.

15. The method according to claim 19, wherein said delaying comprises a processor responsive to said command data switching an amplifier in said processing of said digital audio data.

16. A computer readable medium containing software instructions that, when executed by a processor in a cordless telephone, performs the steps of:
processing command data separated from a digital data stream containing said command data and digital audio data; and
delaying processing of said digital audio data in response to said processing of said command data.

17. The computer readable medium according to claim 16, wherein said processing of command data comprises converting said command data into a digital binary form.

18. The computer readable medium according to claim 16, wherein said command data is separated from said digital audio data by a frequency filtering where said command data is at a lower data rate than said digital audio data.
